(19) United States
(12) Patent Application Publication
(10) Pub. No.: US 2002/0079044 A1
(43) Pub. Date: Jun. 27, 2002

(54) Method and apparatus for the production of hollow bodies

(75) Inventors: Jurgen Feil, Leobendorf (DE); Andreas Staudinger, Freilassing (DE)

Correspondence Address: Thomas C. Pontani, Esq., Cohen, Pontani, Lieberman & Pavane, 551 Fifth Avenue, Suite 1210, New York, NY, 10176, US

(73) Assignee: Kiefel Technologies, Inc.

(21) Appl. No.: 10/021,164

(22) Filed: Dec. 12, 2001

(30) Foreign Application Priority Data
Dec. 22, 2000 (DE) 100 64 218.7

(51) Int. Cl. B31F 1/00

(52) U.S. Cl. 156/217; 156/218

(57) ABSTRACT

An apparatus for the production of hollow bodies comprises two forming stations (18, 19) and two heating stations (26, 29) and also two transport devices (20a, 20b) which in each case transport a plastic sheet to a heating station and subsequently to a forming station. Each forming station (18, 19) has a preforming die and a forming die, and, for the connection operation, the forming die of one forming station (18) is moveable, in alignment with the remaining forming die of the other forming station (19), in exchange for the preforming die of the latter. The forming stations (18, 19) are capable of being operated independently of one another, the transport devices (20a, 20b) transporting to the forming stations from opposite directions.

The invention relates to a method for the production of hollow bodies, in which two plastic sheets are heated, preformed, ready-formed and connected to one another. The invention also relates to an apparatus for carrying out the method.

The production of hollow bodies in the specified way is also designated as the twin-sheet method. A method of this kind may be gathered from U.S. Pat. No. 3,854,860. There, an upper forming die and an upper preforming die and also a lower forming die and a lower preforming die are in each case arranged on a common plate, so that these dies can be moved only simultaneously in order to carry out a forming operation. This is not a serious disadvantage in the production of hollow bodies of symmetrical shape, using equal plastic sheets, but a method of this kind has disadvantages in the case of asymmetric hollow bodies and, in particular, using unequal plastic sheets, because the unequal plastic sheets require unequal shaping and therefore different movements of the forming dies. Furthermore, a method of the type specified in the introduction is known from U.S. Pat. No. 5,658,523. There, too, the forming of the plastic sheets takes place in the same cycle, and also, above all, the heating of the sheets takes place in a single heating station, so that, here too, essentially the production of hollow bodies remains restricted to those with identical pairs of sheets.

The difficulties in both methods are that heating and preforming cannot be carried out independently for the respective plastic sheets, so that the different requirements of the respective plastic sheets cannot be dealt with. Moreover, in these methods and apparatuses, there is no possibility of providing inserts in the hollow bodies, such as may be necessary in the case of fuel tanks for motor vehicles.

The object of the invention is to specify a method and an apparatus, with the aid of which the heating, preforming and final forming of each individual plastic sheet can be carried out, in coordination with the individual requirements of this sheet, independently and so as to be uninfluenced by the treatment of the other plastic sheet, and in which it is even possible, during the production of hollow bodies, also to provide inserts in these hollow bodies.

Proceeding from a method of the type specified in the introduction, this object is achieved, according to the invention, in that the heating, preforming and ready-forming of each plastic sheet take place independently and so as to be uninfluenced by the other plastic sheet in each case.

By virtue of this organisation of the method, not only is it possible to produce hollow bodies of symmetrical shape and from equal plastic sheets, but there is the possibility of having different heating times and carrying out different forming operations with respect to each of the two parts forming the finished hollow body. Moreover, it is ensured that the exertion of mutual influences, for example emanating from the heating stations, is ruled out. Finally, as a result, the precondition for also providing inserts in the hollow body to be produced is afforded.

The method according to the invention advantageously provides for the heating of each plastic sheet to take place not only independently in time, but also so as to be spatially shielded from the other plastic sheet in each case. The exertion of mutual thermal influences, whether due to radiation action or convection, is thereby ruled out.

In a preferred development of the invention, the feed of the plastic sheets to separate heating stations takes place in opposite directions. The exertion of mutual influence is thereby reliably ruled out on account of the existing spatial distance.

Should the conditions of space not allow generous spatial separation, with the feed taking place in opposite directions, the feed of the plastic sheets to separate heating stations may take place in the same direction, but so as to be thermally shielded.

In a further advantageous embodiment of the present method, a preexpansion plunger is used for preforming. It may also be expedient, however, for an insert remaining in the hollow body to be used for preforming. Depending on the body to be produced, it may also be advantageous if, in a development of the invention, a preexpansion plunger and an insert remaining in the hollow body are used for preforming. By an insert remaining in the hollow body being used, it is possible, for example in the case of fuel tanks for motor vehicles, to insert partitions which avoid an excessively vigorous movement of liquid in the tank due to centrifugal forces and acceleration forces. In this case, the production operation may be controlled in such a way that the insert is welded or clamped or adhesively bonded to at least one of the two parts of the hollow body. Welding in this case takes place by virtue of the heat content of at least one of the parts forming the hollow body. It is also possible, however, for the insert to be additionally heated, in order to assist the welding operation. A clamping connection may be made, for example, by the insert being clamped in a groove formed in the hollow body.

A first possibility for the design of an apparatus for carrying out the method, with two forming stations and two heating stations and also two transport devices which in each case transport a plastic sheet to a heating station and subsequently to a forming station, each forming station having a preforming die and a forming die, and, for the connecting operation, the forming die of one forming station being moveable, in alignment with the remaining forming die of the other forming station, in exchange for the preforming die of the latter, is characterized in that the forming stations are arranged next to one another so as to be capable of being operated independently of one another, and the transport devices transport to the forming stations from opposite transport directions.

Such an apparatus is suitable for carrying out the independent and uninfluenced treatment of the individual plastic sheets, thus making it possible to produce different types of hollow bodies. In this embodiment, a relatively large amount of space is required, since the transport devices transport to the forming stations from different directions, but this embodiment has the advantage that the exertion of mutual influences, emanating, for example, from the heating stations, with regard to the plastic sheets to be transported cannot occur.

A variant of such an apparatus for carrying out the method, said variant managing with a smaller amount of space required, is characterized in that the forming stations are arranged next to one another so as to be capable of being operated independently of one another, and the transport devices transport to the forming stations from the same transport directions. In such an embodiment, it may be necessary, when the heating stations are arranged next to one another, to have to provide thermal separation between the heating stations along the transport path.

If, in a further embodiment of the invention, the transport devices comprise transport systems running in a straight line, this affords the possibility of use for a very large number of current transport systems obtainable on the market.

In a further embodiment of the invention, an extremely space-saving and yet structurally simple solution, with all the advantages of the spatially separated arrangement of the heating stations, is obtained if the transport devices comprise transport systems in the manner of turntables. In this case, the directions of rotation of the two transport devices may be opposite or the same.

If, for reasons of space, the heating devices or heating stations have to be arranged very near to one anther and also in respect of the forming stations, there is provision, in a further embodiment of the invention, for a heat-insulating shield to be provided at least partially around the heating stations.

In order to ensure that each forming station operates independently, there is provision for the preforming die to be displaceable or pivotable, independently of the associated forming die, transversely to the displacement direction, that is to say stroke direction, provided for preforming.

If the preforming die is held easily exchangeably on a table, not only can it be exchanged for other preforming dies which are better adapted to the manufacturing operation, but an exchange for an insert remaining in the hollow body can also be carried out in a simple way. In addition to the preforming die, an insert remaining in the hollow body may also be held releasably.

A preferred embodiment of the apparatus is obtained in that a first forming station has an upper preforming die and a lower forming die and a second forming station has a lower preforming die and an upper forming die, in that a slide device for displacing the lower preforming die of the second forming station out of and into the latter and also a slide device for displacing the lower forming die out of the first forming station into the second forming station and back again are provided, and in that the slide devices are capable of being jointly driven. Depending on the respective application, it may be advantageous for the slide devices to be capable of being driven separately. A simple and space-saving connection between the two forming stations is thereby made, in order, despite the use of preforming dies, to make it possible to have a simple design of the forming stations, for the production of hollow bodies.

If, in a further embodiment of the invention, the lifting drive for the preforming die of the second forming station also serves at the same time as a lifting drive for the forming die of the first forming station, said forming die being pushed into the second forming station, and is designed for exerting the pressing forces necessary for the operation of connecting the two mouldings in order to produce the hollow body, the outlay in structural terms in the case of the second forming station is thereby reduced.

In order to adapt the respective forming stations in terms of design to the forces occurring in each case, there is provision for the second forming station to have a more robust design than the first forming station in order to absorb the pressing forces occurring during the connection operation.

The invention is explained in more detail below with reference to diagrammatically illustrated embodiments of apparatuses for the production of hollow bodies. In the drawing:

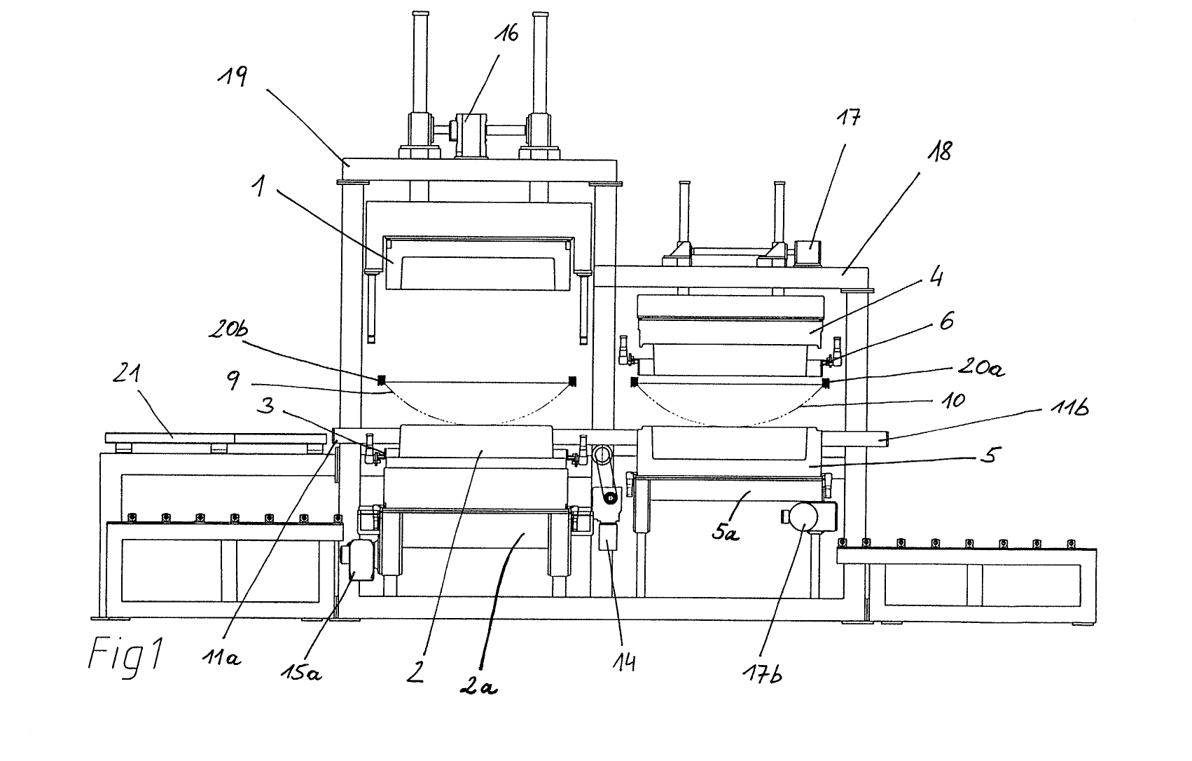

FIGS. 1 to 6: show an apparatus for the production of hollow bodies in a side view and in various working positions;

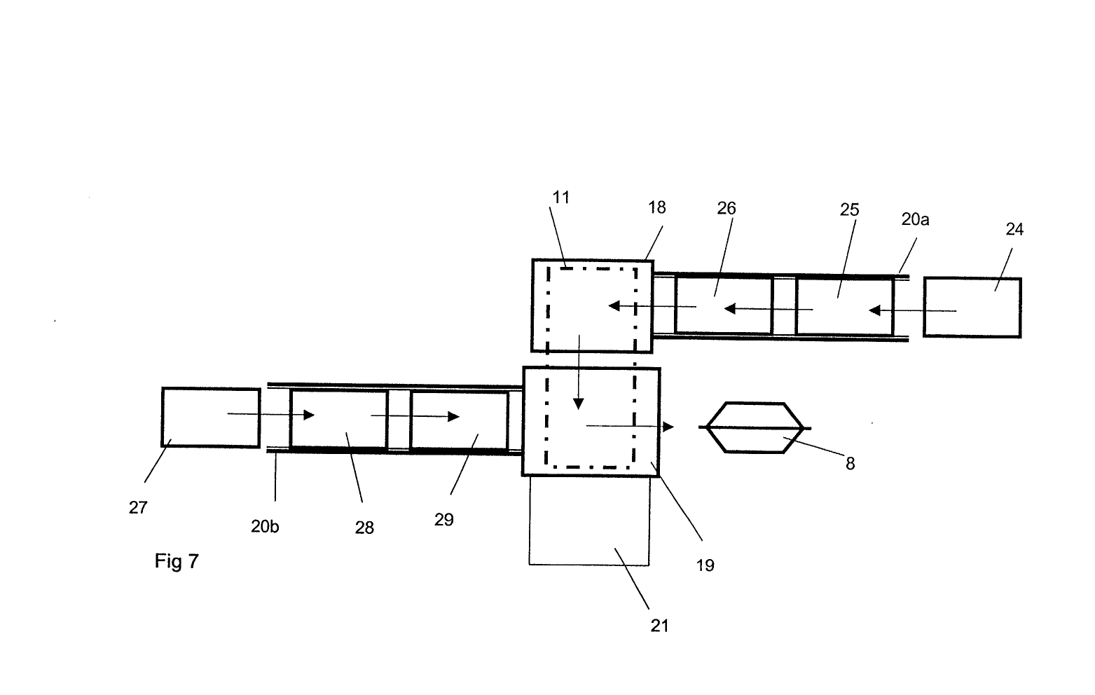

FIG. 7: shows a top view of an embodiment of a diagrammatically illustrated apparatus;

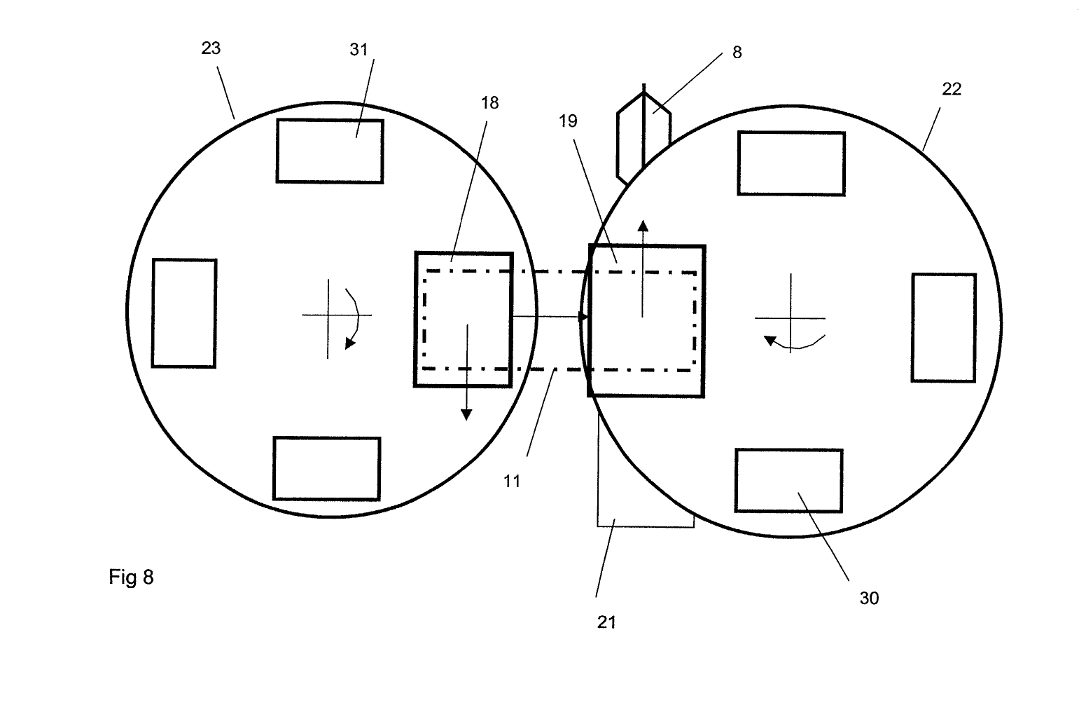

FIG. 8: shows a top view of a second embodiment of an apparatus;

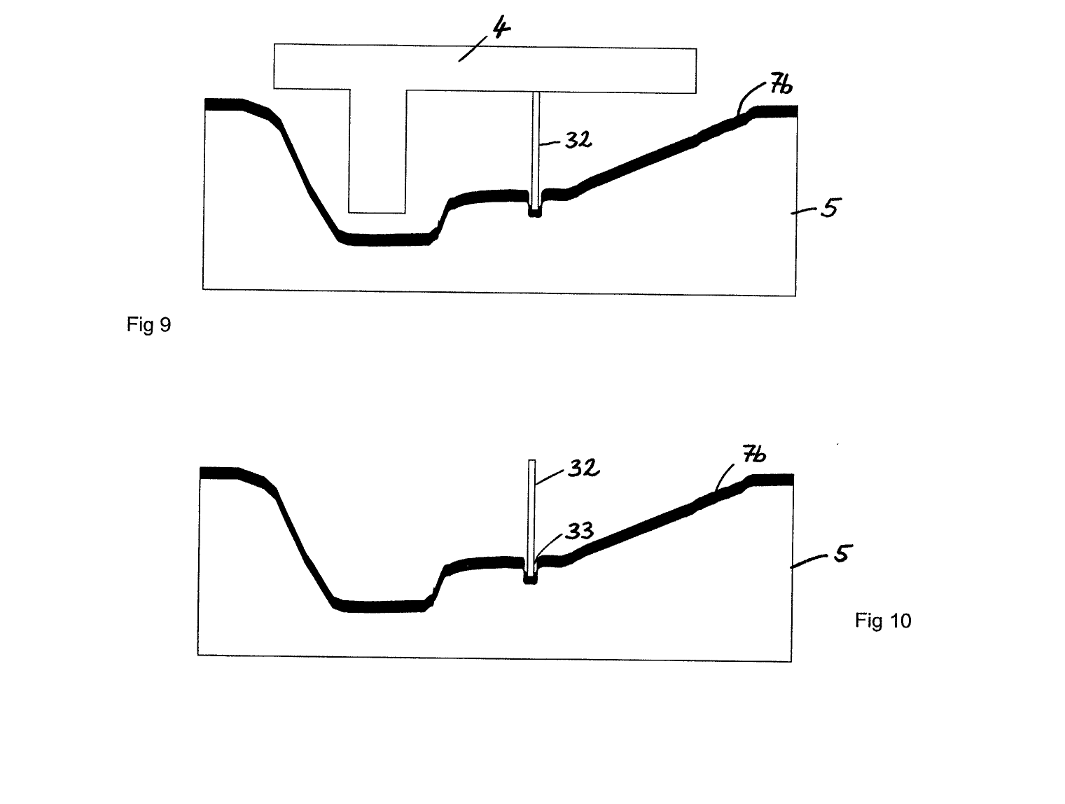

FIG. 9: shows an enlarged illustration of a lower part of a hollow body with a preforming die and with an additional insert; and

FIG. 10: shows the lower part of the hollow body with the remaining insert.

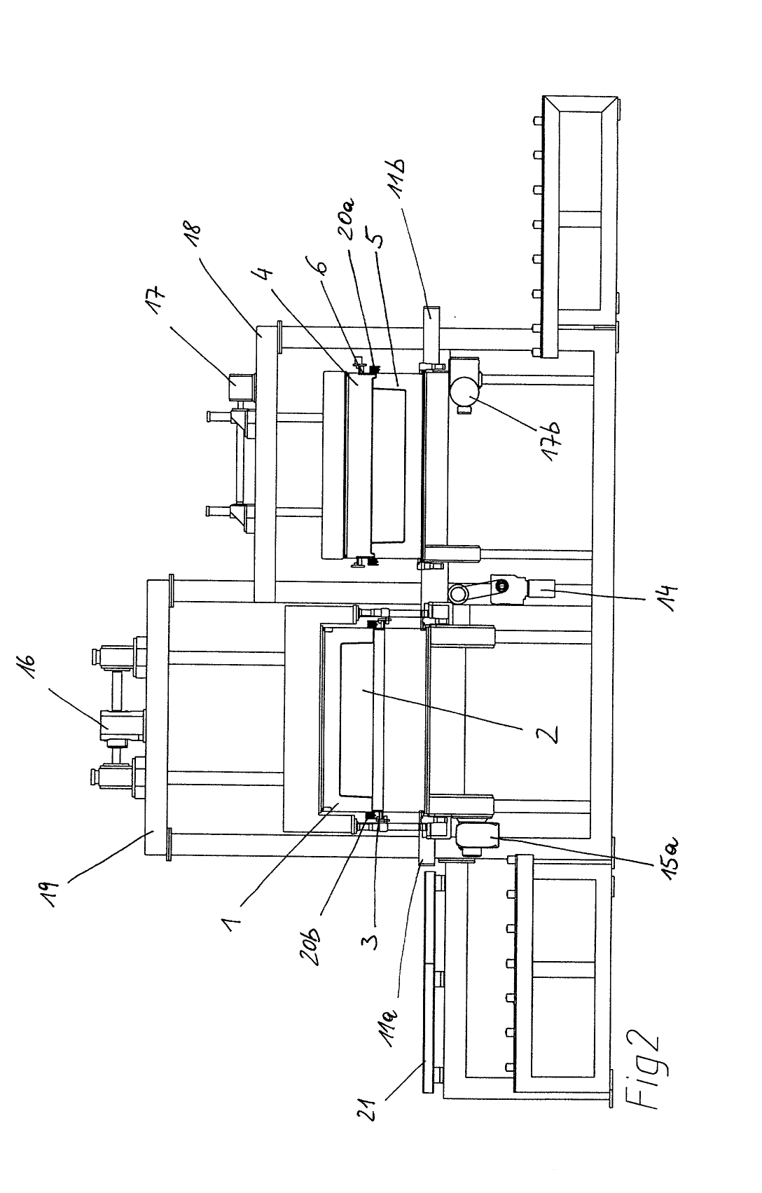

As is clear from FIGS. 1 to 6, two forming stations 18 and 19 are arranged next to one another. The first forming station 18 comprises a lower forming die 5 and also an upper preforming die 4, in order to preexpand a plastic sheet 10, indicated by dot-and-dashed lines, and to ready-form said plastic sheet in the forming die 5 in a known way, using a vacuum, to obtain a lower moulding 7b of a hollow body 8 to be produced. In this case, the plastic sheet 10 is held by a transport device 20a and transported into the forming station 18. During the preforming operation and the ready-forming operation, the plastic sheet 10 is held by a chucking frame 6. For the preforming operation, the preforming die 4 is lowered by means of a drive 17 and, after the end of this preforming operation, is raised again, as may be gathered from the different height positions shown in FIGS. 1 and 2. The lower forming die 5 is arranged on a table 5a. The forming die 5 is moved, together with the table 5a, towards the lowered preforming die 4 by means of a lower drive 17b, so that the plastic sheet can be taken over for the subsequent vacuum-forming operation.

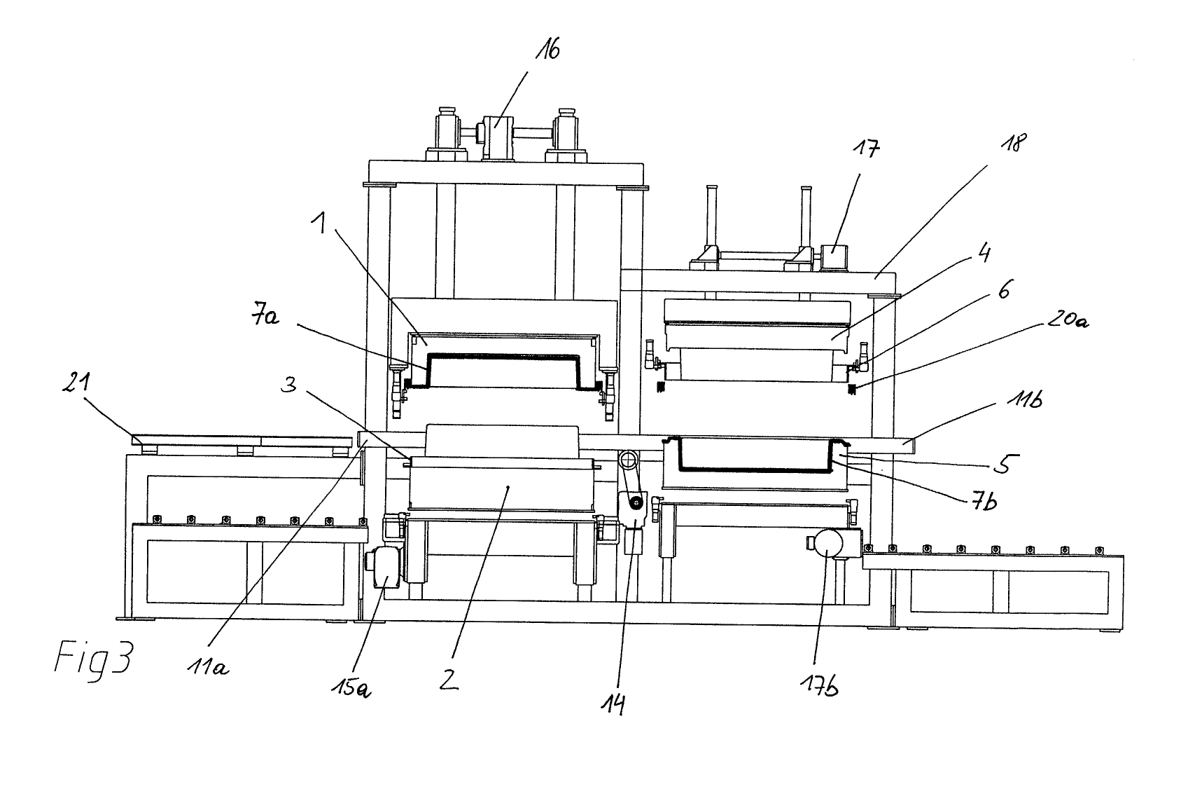

A further plastic sheet 9 conveyed by means of a transport device 20b into a forming station 19 arranged next to the forming station 18 is clamped by a chucking frame 3, in order to preform this plastic sheet by means of a preforming die 2 in a similar way to the forming station 18, the plastic sheet being preformed against an upper forming die 1, in which ready-forming takes place in the usual way by means of a vacuum. For this forming operation, the upper forming die 1 is lowered by means of a drive 16 and a drive 15a serves for raising a table 2a carrying the performing die 2. This preforming die 2 is held easily exchangeably on the table 2a and can be exchanged in a simple way for an insert remaining in the hollow body 8 to be produced. The initial position is in this case illustrated in FIG. 1 and the preforming operation in FIG. 2. FIG. 3 shows the finished parts 7a and 7b in the respective forming dies 1 and 5 of the forming stations 19 and 18.

The preforming die 2 is assigned to a part-slide 11a and the forming die to a part-slide 11b for horizontal transport, said part-slides being combined into a slide 11 moveable by means of a drive 14.

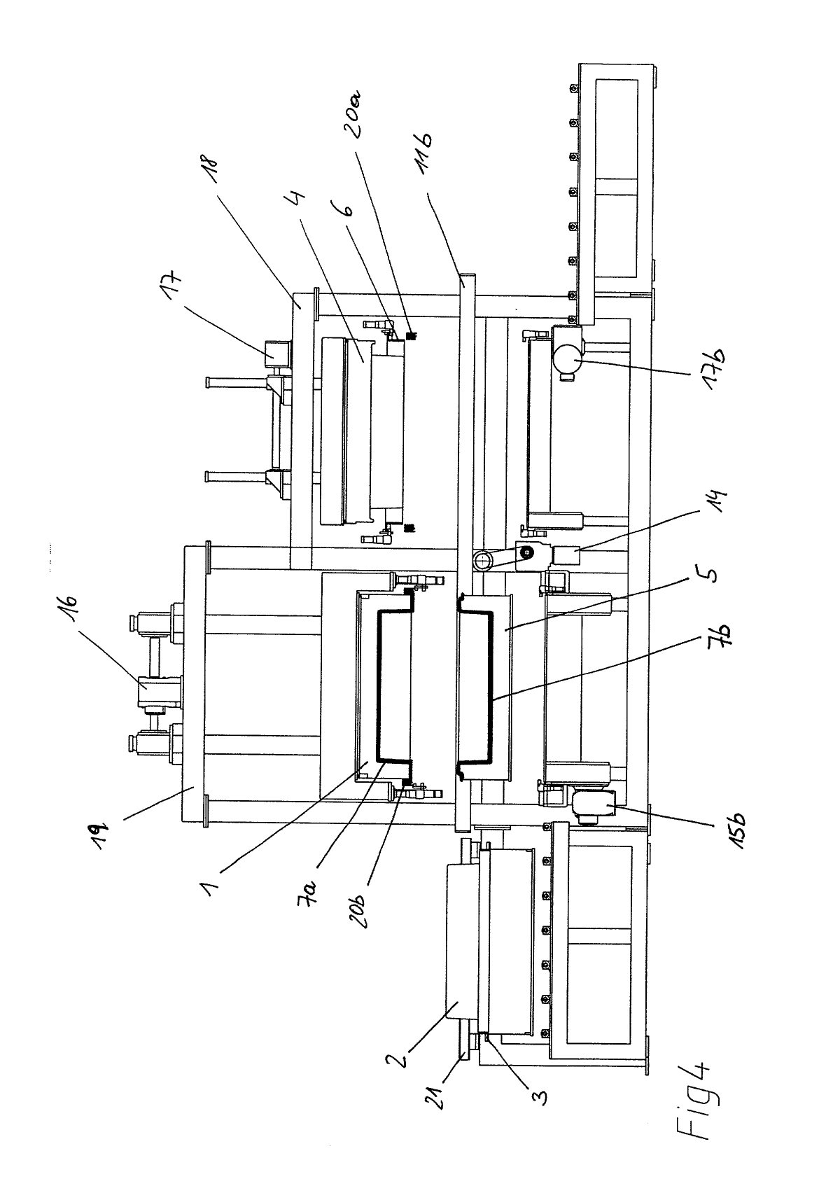

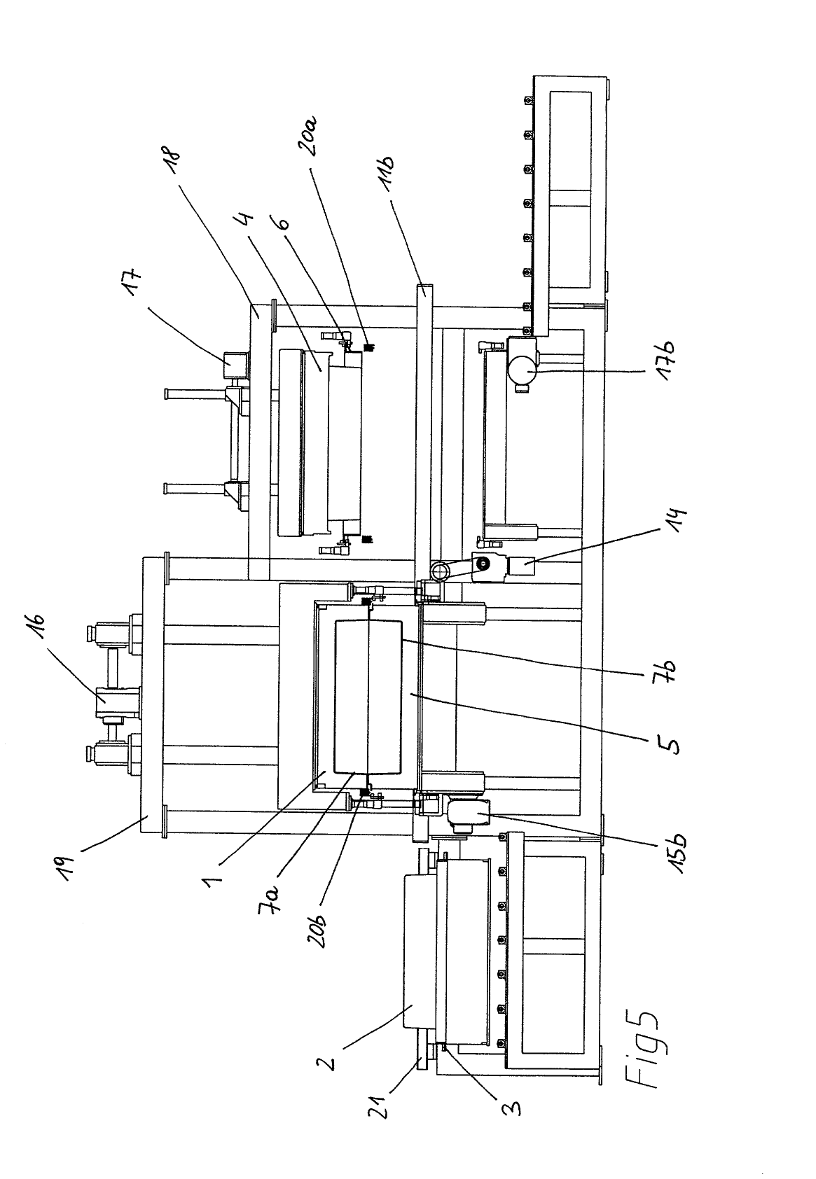

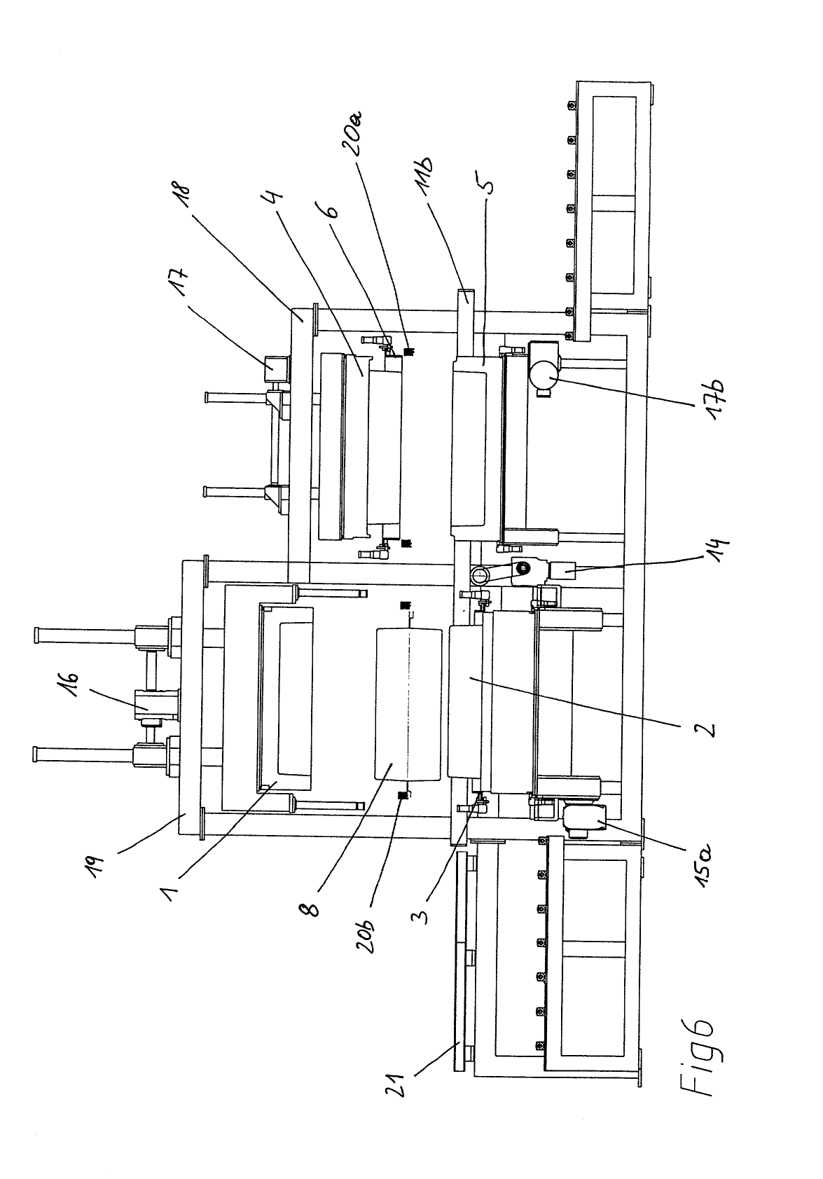

When the two mouldings 7a and 7b are manufactured by preforming and ready-forming, the slide 11a of the forming station 19 is moved on a guide 21 out of the position evident in FIG. 3 into the position, which can be seen in FIG. 4, next to the forming station 19. This affords space for the lower forming die 5 of the forming station 18, said forming die being moveable by means of the slide 11b, on a guide arranged at the same height as the guide 21, from the forming station 18 into the forming station 19, where it is located, in alignment, opposite the upper forming die 1. The lifting drive, designated in FIGS. 1 to 3 by 15a, for the table 2a of the preforming die 2 is then designated in FIG. 5 by 15b in order to emphasize a further function, and, in conjunction with the drive 16, serves for moving the two forming dies 1 and 5 towards one another and for pressing the mouldings 7a and 7b contained in these forming dies against one another and thus connecting them in the edge region. Should an insert be used in addition to a preforming die or instead of the preforming die 2, during this pressing operation this insert can be welded to the inside of the mouldings 7a and 7b or be clamped in a groove formed in the moulding. This pressing operation is illustrated in FIG. 5, whilst FIG. 6 shows the finished hollow body 8 lying on the preforming die 2 which in the meantime has been moved into the forming station 19 again. The upper forming die 1 is raised into an upper position by means of the drive 16.

All energy connections, vacuum, thermal control, etc. for the forming die 5 are maintained during the sliding movement. As a result, during the sliding movement and the subsequent pressing operation, the moulding 7b lies, form-locked, in the forming die 5 and is kept at connection temperature for the connection operation.

FIG. 7 shows a diagrammatic illustration of the forming stations 18 and 19 in a top view, the transport devices 20a and 20b and also the plastic sheets 9 and 10 and the heating devices 26 and 29 being indicated diagrammatically here in this illustration. 24 and 27 designate in each case sheet feed systems which transfer the plastic sheets 9 and 10 from respective stacks onto the transport devices 20a and 20b. The arrows depicted show the transport direction of the respective plastic sheets. It can be seen from this that the transport directions for the respective sheets are oriented opposite to one another, so that the heating stations 26 and 29 are arranged at a short distance from one another on sides facing away from one another with respect to the forming stations 18 and 19. Damage caused by thermal radiation or convection is thus ruled out.

FIG. 8 likewise shows a diagrammatic illustration of another type of design of the apparatus for the production of hollow bodies. Two transport systems in the form of turntables 22 and 23 are provided here, these turntables in each case having opposite directions of rotation. These turntables convey the plastic sheets 10 and 9 into the respective forming stations 18 and 19, and, before the plastic sheets are introduced into the forming stations, they run through the respective heating stations 30 and 31, where they are brought to the corresponding preforming temperature. Here, too, because turntables 22 and 23 are used, the heating stations 30 and 31 are located diametrically opposite one another with respect to the forming stations 18 and 19 and are therefore at a very long spatial distance from one another, in order to avoid the exertion of mutual influence. The distance to the respective forming stations is likewise such that damage to the forming station by the heating station is avoided.

FIGS. 9 and 10 show, in greatly enlarged form, the lower forming die 5 with the lower moulding 7b in the already finished form, FIG. 9 also showing the preforming die 4 carrying in releasable form an insert 32 which, as is evident from a comparison of FIG. 9 and FIG. 10, is clamped into a groove 33 integrally formed in the moulding 7b so as to remain in this lower moulding 7b. FIG. 9 shows the situation shortly before the insert 32 is separated from the preforming die 4 on which this insert is held releasably. FIG. 10 shows the situation with a firmly clamped insert 32 which, for example, constitutes a partition in a hollow body to be produced.

1. Method for the production of hollow bodies, in which two plastic sheets are heated, preformed, ready-formed and connected to one another, characterized in that the heating, preforming and forming of each plastic sheet take place independently and so as to be uninfluenced by the other plastic sheet in each case.

2. Method according to claim 1, characterized in that the heating of each plastic sheet takes place not only independently in time, but also so as to be spatially shielded from the other plastic sheet in each case.

3. Method according to claim 1 or 2, characterized in that the feed of the plastic sheets to separate heating stations takes place in opposite directions.

4. Method according to claim 1 or 2, characterized in that the feed of the plastic sheets to separate heating stations takes place in the same direction, but so as to be thermally shielded.

5. Method according to one of claims 1 to 4, characterized in that a preexpansion plunger is used for preforming.

6. Method according to one of claims 1 to 4, characterized in that an insert remaining in the hollow body is used for preforming.

7. Method according to one of claims 1 to 6, characterized in that a preexpansion plunger and an insert remaining in the hollow body are used for preforming.

8. Method according to claim 6, characterized in that the insert is welded to at least one of the two parts of the hollow body.

9. Method according to claim 6, characterized in that the insert is clamped in at least one of the two parts of the hollow body.

10. Method according to claim 6, characterized in that the insert is adhesively bonded to at least one of the two parts of the hollow body.

11. Method according to claim 6, characterized in that the insert is additionally heated.

12. Apparatus for carrying out the method according to one of claims 1 to 11, with two forming stations and two heating stations and also two transport devices which in each case transport a plastic sheet to a heating station and subsequently to a forming station, each forming station having a preforming die and a forming die, and, for the connection operation, the forming die of one forming station being moveable, in alignment with the remaining forming die of the other forming station, in exchange for the preforming die of the latter, characterized in that the forming stations (18, 19) are arranged next to one another so as to be capable of being operated independently of one another, and the transport devices (20a, 20b; 22, 23) transport to the forming stations from opposite transport directions.

13. Apparatus for carrying out the method according to one of claims 1 to 11, with two forming stations and two heating stations and also two transport devices which in each case transport a plastic sheet to a heating station and subsequently to a forming station, each forming station having a preforming die and a forming die, and, for the connection operation, the forming die of one forming station being moveable, in alignment with the remaining forming die of the other forming station, in exchange for the preforming die of the latter, characterized in that the forming stations (18, 19) are arranged next to one another so as to be capable of being operated independently of one another, and the transport devices transport to the forming stations form the same transport directions.

14. Apparatus according to claim 12 or 13, characterized in that the transport devices (20a, 20b) comprise transport systems running in a straight line.

15. Apparatus according to claim 12 or 13, characterized in that the transport devices (22, 23) comprise transport systems in the manner of turntables.

16. Apparatus according to claim 15, characterized in that the directions of rotation of the two transport devices (22, 23) are opposite.

17. Apparatus according to claim 15, characterized in that the directions of rotation of the two transport devices (22, 23) are the same.

18. Apparatus according to claim 13 or 14, characterized in that a heat-insulating shield is provided at least partially around the heating stations (26, 29; 30, 31).

19. Apparatus according to one of claims 12 to 18, characterized in that the preforming die (2, 4) is displaceable or pivotable, independently of the associated forming die (1, 5), transversely to the displacement direction or stroke direction provided for preforming.

20. Apparatus according to one of claims 12 to 19, characterized in that the preforming die (2, 4) is held easily exchangeably on a table (2a, 5a).

21. Apparatus according to one of claims 12 to 20, characterized in that a first forming station (18) has an upper preforming die (4) and a lower forming die (5) and a second forming station (19) has a lower preforming die (2) and an upper forming die (1), in that a slide device (11, 14) for displacing the lower preforming die (2) of the second forming station (19) out of and into the latter and also a slide device (11, 14) for displacing the lower forming die (5) out of the first forming station (18) into the second forming station (19) and back again are provided, and in that the slide devices are capable of being jointly driven.

22. Apparatus according to one of claims 12 to 20, characterized in that a first forming station (18) has an upper preforming die (4) and a lower forming die (5) and a second forming station (19) has a lower preforming die (2) and an upper forming die (1), in that a slide device (11, 14) for displacing the lower preforming die (2) of the second forming station (19) out of and into the latter and also a slide device (11, 14) for displacing the lower forming die (5) out of the first forming station (18) into the second forming station (19) and back again are provided, and in that the slide devices are capable of being driven separately.

23. Apparatus according to one of claims 12 to 22, characterized in that the lifting drive (15a) for the preforming die (2) of the second forming station (19) also serves at the same time as a lifting drive (15b) for the forming die (5) of the first forming station (18), said forming die being pushed into the second forming station (19), and is designed for exerting the pressing force necessary for the operation of connecting the two mouldings in order to produce the hollow body (8).

24. Apparatus according to claim 23, characterized in that the second forming station (19) is of more robust design than the first forming station (18) in order to absorb the pressing forces occurring during the connection operation.
